(19) United States
(12) Patent Application Publication
(10) Pub. No.: US 2025/0077793 A1
(43) Pub. Date: Mar. 6, 2025

(54) Vector Databases for Determining Machine-Learned Model Inputs

(71) Applicant: KX Systems, Inc., New York, NY (US)

(72) Inventor: Paul Colgan, New York, NY (US)

(21) Appl. No.: 18/461,282

(22) Filed: Sep. 5, 2023

(51) Int. Cl. G06F 40/40; G06F 16/31; G06F 16/33

(52) U.S. Cl. CPC G06F 40/40; G06F 16/31; G06F 16/3347

(57) ABSTRACT

A query embedding is obtained for a vector representation of a query. A vector database is queried with the query embedding to identify one or more result embeddings. The vector database can include a plurality of embeddings for a respective plurality of vector representations of data items. The query, and one or more of (a) one or more data items of the plurality of data items respectively associated with the one or more result embeddings, or (b) the one or more result embeddings, can be processed with a machine-learned model to obtain a model output. The model output can be provided for a requesting entity associated with the query.

### FIELD

The present disclosure relates generally to vector-based databases. More particularly, the present disclosure relates to indexing vector embeddings in databases to facilitate more optimal results from machine-learned models.

### BACKGROUND

Foundational models are a relatively recent development in the field of machine learning. Foundational models are powerful generative models with many parameters (e.g., millions or more) that are trained with large quantities of training data to perform a wide variety of tasks. For example, Large Language Models (LLMs) are generally trained on large quantities of textual content to perform natural language processing tasks such as answering queries. However, the accuracy of outputs generated by foundational models is subject to the information used to train the model. This issue is compounded by the prohibitively expensive computational costs associated with training a foundational model. For example, if queried regarding current events that have taken place in the last 24 hours, it is unlikely that an LLM will provide an accurate answer, as the LLM will not have yet been trained with information describing the current events.

### SUMMARY

Aspects and advantages of embodiments of the present disclosure will be set forth in part in the following description, or can be learned from the description, or can be learned through practice of the embodiments.

One example aspect of the present disclosure is directed to a A computer-implemented method. The method includes obtaining, by a computing system comprising one or more computing devices, a query embedding for a vector representation of a query. The method includes querying, by the computing system, a vector database with the query embedding to identify one or more result embeddings, wherein the vector database comprises a plurality of embeddings for a respective plurality of vector representations of data items. The method includes processing, by the computing system, a set of inputs with a machine-learned model to obtain a model output, the set of inputs comprising the query and one or more of: (a) one or more data items of the plurality of data items respectively associated with the one or more result embeddings; or (b) the one or more result embeddings. The method includes providing, by the computing system, the model output for a requesting entity associated with the query.

Another example aspect of the present disclosure is directed to a computing system, comprising one or more processors and one or more non-transitory computer-readable media that collectively store a first set of instructions that, when executed by the one or more processors, cause the computing system to perform operations. The operations include obtaining a query embedding for a vector representation of a query. The operations include querying a vector database with the query embedding to identify one or more result embeddings, wherein the vector database comprises a plurality of embeddings for a respective plurality of vector representations of data items. The operations include processing a set of inputs with a machine-learned model to obtain a model output, the set of inputs comprising the query and one or more of (a) one or more data items of the plurality of data items respectively associated with the one or more result embeddings, or (b) the one or more result embeddings. The operations include providing the model output for a requesting entity associated with the query.

Another example aspect of the present disclosure is directed to one or more non-transitory computer-readable media that collectively store a first set of instructions that, when executed by one or more processors, cause the one or more processors to perform operations. The operations include obtaining a query embedding for a vector representation of a query. The operations include querying a vector database with the query embedding to identify one or more result embeddings, wherein the vector database comprises a plurality of embeddings for a respective plurality of vector representations of data items. The operations include processing a set of inputs with a machine-learned model to obtain a model output, the set of inputs comprising the query and one or more of (a) one or more data items of the plurality of data items respectively associated with the one or more result embeddings, or (b) the one or more result embeddings. The operations include providing the model output for a requesting entity associated with the query.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an environment suitable for vector databases for determining model inputs according to some implementations of the present disclosure.

FIG. 2 is a data flow diagram for leveraging a vector database to determine machine-learned model inputs according to some implementations of the present disclosure.

FIG. 3 is a flowchart for determining machine-learned model inputs with vector databases according to some implementations of the present disclosure.

FIG. 4 depicts a block diagram of an example computing system that processes determined inputs with machine-learned models according to example implementations of the present disclosure.

Reference numerals that are repeated across plural figures are intended to identify the same features in various implementations.

### DETAILED DESCRIPTION

### Overview

Generally, the present disclosure is directed to vector-based databases. More particularly, the present disclosure relates to indexing vector embeddings in databases to facilitate more optimal results from machine-learned models. For example, as described previously, some machine learning models are constrained by the recency of information used to train the model. In particular, models such as Large Language Models (LLMs) can generate inaccurate outputs if queried regarding events that take place subsequent to training of the model. In other words, the output of a model is only as good as the data used to train the model.

One technique to generate more accurate outputs with machine learned models is to provide the model access to contextual information along with a query. For example, rather than prompting a large language model with only the query “which companies have had the most surprising stock growth in the past few months,” a user may instead append contextual information along with the query (e.g., stock performance history for various companies, etc.).

However, retrieving contextual information to optimize model outputs can be prohibitively difficult. In particular, due to the sheer quantity of possible contextual information to select from, searching for optimal contextual information is computationally expensive. In addition, determining a semantic similarity between a query and contextual information is a computationally difficult process that is exacerbated by the sheer quantity of possible contextual information. In conjunction, these inefficiencies make the storage and retrieval of contextual information inefficient.

Accordingly, implementations of the present disclosure propose vector databases for determining inputs for machine-learned models. Specifically, a computing system can be, or otherwise implement, a vector database management system. The vector database management system can include a vector database. The vector database can store vector representations of data items (e.g., documents, images, raw textual content, contents of files (e.g., slides, spreadsheets, etc.), programmatic code, etc.). The vector database can also store an embedding of each vector. For example, the vector database management system can process each vector with a machine-learned embedding model (e.g., a transformer model, etc.), and can map the embedding to an embedding space. The relative “distance” between embeddings in an embedding space serves as a relatively accurate representation of semantic similarity. As such, the vector database management system can efficiently determine a semantic similarity between vectors based on the relative distance between their respective embeddings within the embedding space.

The vector database management system can utilize the vector database to accurately and efficiently determine inputs for a machine-learned model. For example, the vector database management system can obtain a query from a requesting entity (e.g., another computing system, a user, etc.). The vector database management system can encode the query as a vector and can generate an embedding for the vector. The vector database management system can map the vector to the embedding space and select data items with associated embeddings that are located relatively close to the query embedding within the embedding space. The vectors for the selected data items (and/or the selected data items) can be processed along with the query with a machine-learned model (e.g., a generative model, a discriminative model, a LLM, etc.) to obtain a model output. The model output can be provided for the requesting entity (e.g., transmitted to the requesting entity, provided for display to the requesting entity, etc.). In such fashion, the vector database management system can leverage a vector database to accurately and efficiently select contextual information for a query to generate more optimal model outputs.

Aspects of the present disclosure provide a number of technical effects and benefits. As one example technical effect and benefit, implementations of the present disclosure substantially, reduce the computational expenses associated with retrieval of information from conventional databases that is semantically similar to a query. Specifically, conventional databases may require a similarity search to be performed for each data item stored in a database, necessitating the expenditure of substantial computing resources (e.g., power, memory, compute cycles, storage, etc.). Conversely, vector database implementations of the present disclosure can determine a semantic similarity between data items in a manner that is orders of magnitude quicker and more efficient than conventional databases, therefore substantially reducing the quantity of computing resources required.

With reference now to the Figures, example embodiments of the present disclosure will be discussed in further detail.

### Example Devices and Systems

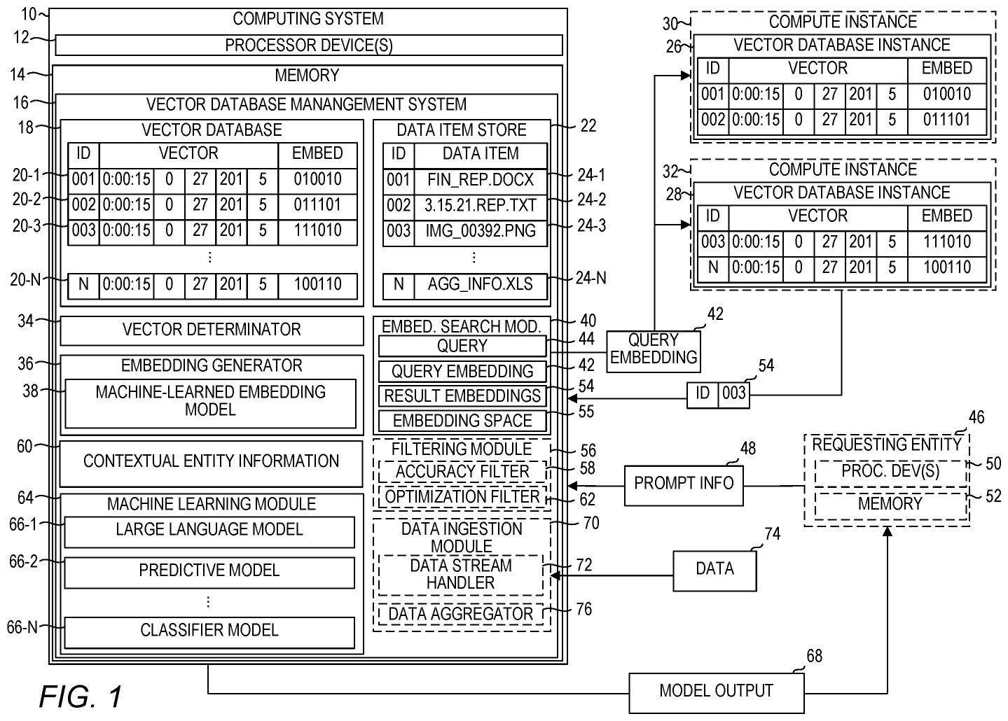

FIG. 1 is a block diagram of an environment suitable for vector databases for determining model inputs according to some implementations of the present disclosure. A computing system 10 includes processor device(s) 12 and memory 14. In some implementations, the computing system 10 may be a computing system that includes multiple computing devices. Alternatively, in some implementations, the computing system 10 may be one or more computing devices within a computing system that includes multiple computing devices. Similarly, the processor device(s) 12 may include any computing or electronic device capable of executing software instructions to implement the functionality described herein.

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can, in some implementations, include a containerized unit of software instructions (i.e., a “packaged container”). A containerized unit of software instructions can collectively form a container that has been packaged using any type or manner of containerization technique.

The memory 14 can include a vector database management system 16. The vector database management system 16 can be a system (e.g., hardware, software, containerized software, compute resources, etc.) that implements and orchestrates a vector database 18. The vector database 18 can include database entries 20-1-20-N (generally, database entries 20). Each database entry can include an identifier, a vector that represents a particular data item, and an embedding for the vector. To follow the depicted example, data entry 20-1 can include an ID (e.g., 001), a vector (e.g., 0:00:15, 0, 27, 201, 5) and an embedding for the vector (e.g., 010010).

In some implementations, the vector database management system 16 can include a data item store 22. The data item store 22 can store data items 24-1-24-N that are each associated with a respective data entry of the data entries 20 (generally, data items 24). For example, the vector of data entry 20-1 can be a vectorized representation of data item 24-1. In some implementations, the data item store 22 can include any type or manner of data items 24, including raw text, formatted text, files (e.g., text files, spreadsheet files, word processor files, slideshow files, etc.), programmatic code, images, video, executables, etc. Alternatively, in some implementations, the data item store 22 can store a particular type of data item 24. For example, each of the data items 24 can be a segment of raw text.

Alternatively, in some implementations, the vector database management system 16 may not implement data item store 22. For example, if the representation of the data items 24 by the vectors of the data entries 20 is sufficiently rich, and the vectors can be processed by machine-learned embedding model 38, the vector database management system 16 can refrain from maintaining the data item store 22, therefore substantially reducing the amount of memory and storage resources required to implement the vector database 18 in comparison to conventional database techniques.

It should be noted that the format, location, and implementation of the vector database are illustrated herein only to more clearly demonstrate various implementations of the present disclosure. For example, in some implementations, the vector database 18 can store vectors separately from embeddings, and can maintain a separate embedding space to which embeddings are mapped. For another example, in some implementations, the vector database 18 can include the data item store 22.

In particular, in some implementations, the vector database management system 16 can manage multiple instances of the vector database 18. For example, the vector database management system 16 can partition the vector database 18 for parallel processing. Additionally, or alternatively, in some implementations, the vector database management system 16 can instantiate vector database instances 26 and 28. For example, the vector database management system 16 can instantiate vector database instances 26 and 28 in memory 14. For another example, the vector database management system 16 can cause instantiation of compute instances 30 and 32 by other computing devices to implement vector database instances 26 and 28, respectively. In some implementations, the vector database instances 26 and 28 can each include each of the data entries 20. Alternatively, in some implementations, the data entries 20 can be partitioned across the vector database instances 26 and 28. To follow the depicted example, vector database instance 26 can include data entries 20-1 and 20-2, while vector database instance 28 can include data entries 20-3 and 20-N.

In such fashion, the vector database management system 16 can establish redundancy mechanisms to determine semantic similarity more accurately. For example, the vector database management system 16 can query the vector database 18 and the vector database instances 26 and 28 in parallel to ensure that the resulting data entries are identical from each source. Alternatively, in some implementations, the vector database management system 16 can partition the vector database 16 across the vector database instances 26 and 28, and can query the vector database instances 26 and 28 to substantially increase retrieval speed.

The vector database management system 16 can include a vector determinator 34. The vector determinator 34 can generate vector representations of data items 24 for inclusion in data entries 20. To do so, the vector determinator 34 can be, or otherwise include, a machine-learned encoding model (e.g., a vector embedding model, etc.), a statistical model, etc. In some implementations, the vector determinator 34 can perform Retrieval Augmented Generation (RAG). The vector determinator 34 can perform any type or manner of encoding technique or process to encode the vector representations of the data items 24. For example, if the data item 24-3 is an image, the vector determinator 34 can establish a sparse vector encoding process to efficiently generate a sparse vector representation of the image.

The vector database management system 16 can include an embedding generator 36. The embedding generator 36 can generate embeddings of vectors included in data entries 20. In particular, the embedding generator 36 can include a machine-learned embedding model 38. The machine-learned embedding model 38 can be a machine-learned model, such as a transformer model, that is trained to generate lower-dimensional representations of vectors. For example, if an encoding process performed by the vector determinator produces vectors with 100 values, the machine-learned embedding model 38 can be trained to generate embeddings that include fewer than 100 values (e.g., 10 values, etc.). To follow the depicted example, to generate the embedding for data entry 20-1, the embedding generator 36 can process the vector (0:00:15, 0, 27, 201, 5) to obtain an embedding (e.g., 010010).

The vector database management system 16 can include an embedding search module 40. The embedding search module 40 can query the vector database 18 based on a query embedding 42. The query embedding 42 can be an embedding of a query 44 (i.e., a question, a prompt, a statement, a request, an image, a video, a set of information, etc.). The query 44 can be received from a requesting entity 46, or can otherwise be determined based on prompt information 48 indicative of the query 44 received from the requesting entity 46. For example, the requesting entity 46 can be a user that inputs a query 44 (i.e., a question, a prompt, etc.) via a user input device. For another example, the requesting entity 46 can be a user device that provides the query 44 input by the user. For another example, the requesting entity 46 can be a computing system including a processor device 50 and memory 52 that utilizes vector database services provided by the vector database management system 16.

In some implementations, the query 44 can be received directly from the requesting entity 46. Alternatively, in some implementations, the query 44 can be based on prompt information 48. More specifically, the embedding search module can, in some implementations, formulate a more efficient or optimal query 44 based on prompt information 48 received from the requesting entity 48. For example, if the prompt information 48 includes textual content descriptive of a question, the embedding search module 40 may parse the textual content to formulate a query 44 that is more optimally processed with a machine-learned model. For another example, if the prompt information 48 is an image, the embedding search module 40 can reformat the image to generate a query 44 that is in a proper format for processing by the vector determinator 34.

The query embedding 42 can be an embedding of a vector representation of the query 44. For example, the vector determinator 34 can determine a vector representation of the query 44. The embedding generator 36 can process the vector representation of the query 44 with the machine-learned embedding model 38 to obtain query embedding 42.

The embedding search module 40 can perform a nearest-neighbor, or approximate nearest-neighbor (ANN), search to identify result embedding(s) 54. Result embeddings 54 can be embeddings that are semantically similar to the query embedding 42. More specifically, the result embeddings 54 can be the embeddings located most closely to the query embedding 42 within an embedding space 55. For example, in some implementations, the embedding search module 40 can implement an embedding space 55. An embedding space refers to a lower-dimensional space to which embeddings can be mapped. Prior to receiving the query 44, the embedding search module 40 can populate the embedding space 55 by mapping embeddings generated by the embedding generator 36 to the embedding space 55. The embedding search module 40 can then map the query embedding 42 to the embedding space 55 and perform a nearest neighbor search to identify one or more result embeddings 54 most similar to the query embedding 42. For example, the embedding search module 40 may identify any result embeddings 54 that are within a threshold distance of the query embedding 42 within the embedding space 55. For another example, the embedding search module 40 may identify a certain number of result embeddings 54 closest to the query embedding 42 in the embedding space 55.

It should be noted that, although the embedding space 55 is depicted as being separate from the vector database 18, in some implementations, the embedding space 55 can be a component of the vector database 18, or may be included in the vector database 18. More specifically, because the embedding space 55 is populated by embeddings of vectors included in the data entries 20 of the vector database 18, any reference to “querying” the vector database 18 may refer to querying the embedding space 55 by performing a nearest-neighbor, or approximate nearest-neighbor (ANN), search for a query embedding.

In some implementations, the embedding search module 40 can perform one or more Approximate Nearest Neighbor (ANN) processes to more efficiently determine result embeddings 54 semantically similar to the query embedding 42. To do so, the vector database management system 16 can, in some implementations, include a filtering module 56. The filtering module 56 can apply filters before and/or after the embedding search module 40 queries the embedding space 55 to identify result embedding(s) 54. Specifically, in some implementations, the filtering module 56 can generate an accuracy filter 58 based on the query 44 and/or contextual entity information 60. The contextual entity information 60 can be information stored by the vector database management system 16 that describes various characteristics of the requesting entity 46, or various contextual information relevant to the query 44 or other queries received by the vector database management system 16. For example, assume that the requesting entity 46 is a user device, and the query 44 is a query for movie recommendations for a user of the user device. The contextual entity information 60 may indicate that the user device currently has age-restriction settings enabled. Based on the contextual entity information 60, the accuracy filter 58 can filter mature movies from the data entries 20 (and their corresponding embeddings in the embedding space 55) prior to performing a query.

The vector database management system 16 can include machine learning module 64. The machine learning module 64 can implement (e.g., instantiate, train, update, etc.) one or more machine-learned model(s) 66-1-66-N (generally, machine-learned models 66). The machine-learned models 66 can be any type or manner of model trained to process data items 24 and/or vectors included in data entries 20. To follow the depicted example, the machine learning module 64 can include a large language model 66-1 trained to process textual content.

The machine-learned models 66 can process either the vectors included in the data items 20 or the data items 24 to generate a model output 68. The model output 68 can be provided for the requesting entity 46. For example, if the requesting entity 46 is a user, the model output 68 can be provided for display to the user, and/or transmitted to a user computing device of the user. If the requesting entity 46 is a computing system (e.g., computing device, compute node, compute instance, etc.), the model output 68 can be transmitted to the requesting entity 46.

In some implementations, the filtering module 56 can generate an optimization 62 filter based on the query and/or the contextual entity information 60. The optimization filter 62 can be applied to result embeddings 54, or the data items 24, to obtain filtered result embeddings for processing with machine-learned models.

In some implementations, the vector database management system 16 can ingest data in real-time to provide a more accurate model output 68. In particular, the vector database management system 16 can include a data ingestion module 70. The data ingestion module 70 can be a module that ingests data in real-time from multiple sources. To do so, the data ingestion module 70 can include a data stream handler 72. The data stream handler 72 can establish data streams from various sources to obtain data in real-time. For example, the data stream handler 72 can establish data streams with Internet-of-Things (IoT) devices, information repositories, live news feeds, etc. The data stream received by the data stream handler 72 can include data items. For example, the data stream handler 72 can receive a data stream that includes data item 74.

Upon receipt of the data item 74, the data item 74 can be indexed and stored in the vector database 18. To do so, the vector determinator 34 can determine a vector representation of the data item 74. The embedding generator 36 can process the vector for the data item 74 with the machine-learned embedding model 38 to generate an embedding. The vector database management system 16 can generate a data entry 20 for the data item 74 that includes an ID, the vector, and the embedding for the data item 74. The data item 74 can itself be stored in the data item store 22. In such fashion, the data ingestion module can be utilized to ingest real-time data to reduce, limit, or eliminate, inaccuracies caused by lack of access to recent information.

In some implementations, the data ingestion module 70 can include a data aggregator 76. The data aggregator 76 can aggregate data from data streams handled by the data stream handler 72. For example, assume that the data stream handler 72 establishes a data stream from an IoT device programmed to provide sensor information every second. Keeping all information received from the IoT device would require prohibitive quantities of storage. As such, the data aggregator 76 can aggregate data received via the data stream to obtain a data item that includes aggregated data.

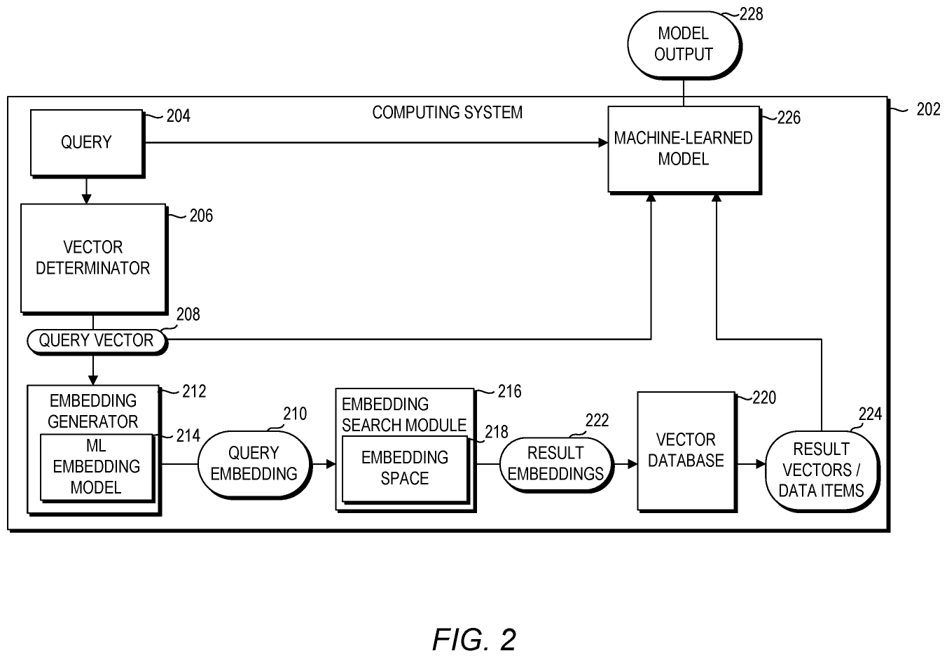

FIG. 2 is a data flow diagram for leveraging a vector database to determine machine-learned model inputs according to some implementations of the present disclosure. Specifically, a computing system 202 can obtain a query 204. The computing system 10 can process the query 204 with a vector determinator 206 to obtain a query vector 208. The query vector 208 can be a vectorized representation of the query 204. The computing system 202 can generate a query embedding 210 that serves as a lower-dimensional representation of the query vector 206 with an embedding generator 212. In particular, the computing system 202 can process the query vector 208 with a machine-learned embedding model 214 to obtain the query embedding 210.

The computing system 202 can provide the query embedding 210 to an embedding search module 216. The embedding search module can include an embedding space 218 populated with embeddings of vectors stored in a vector database 220. In particular, the computing system can efficiently “query” the vector database 220 by performing a nearest-neighbor search, or ANN search, of the embedding space 218 for the query embedding 210 to obtain result embeddings 222. The result embeddings 222 can be embeddings located most closely to the query embedding 210 in the embedding space 218. The computing system can identify result vectors and/or data items 224 associated with the associated with the result embeddings 222.

The computing system can process the result vectors/data items 224 with a machine-learned model 226 to obtain a model output 228. For example, if the vectors are sufficiently representative of the data items associated with the result embeddings 222, the machine-learned model 226 can process the result vectors 224 and the query vector 208 to obtain the model output 228. For another example, the machine-learned model 226 can instead process the query 204 and the data items associated with result vectors 224.

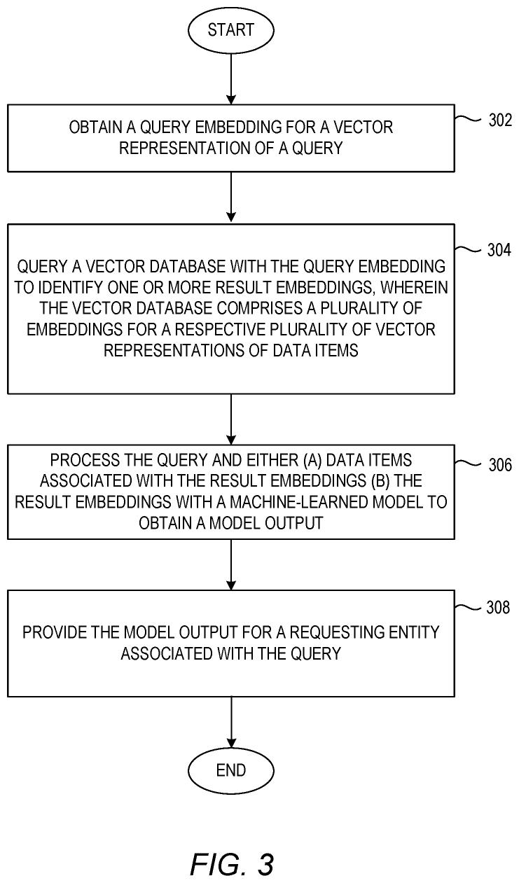

FIG. 3 is a flowchart for determining machine-learned model inputs with vector databases according to some implementations of the present disclosure. Although FIG. 3 depicts steps performed in a particular order for purposes of illustration and discussion, the methods of the present disclosure are not limited to the particularly illustrated order or arrangement. The various steps of the method can be omitted, rearranged, combined, and/or adapted in various ways without deviating from the scope of the present disclosure.

At operation 302, a computing system can obtain a query embedding for a vector representation of a query. For example, the computing system can obtain a query from a requesting entity. The computing system can determine a vector representation of the query. The computing system can generate an embedding of the vector representation.

In some implementations, obtaining the query embedding for the vector representation of the query can include processing the vector representation of the query with a machine-learned embedding model to obtain the query embedding for the vector representation of the query.

In some implementations, prior to obtaining the query embedding, the computing system can receive information indicative of the query from the requesting entity. For example, the computing system can receive initial prompt information from the requesting entity and can formulate the query based on the prompt information. Alternatively, in some implementations, the computing system can receive the query directly from the requesting entity.

In some implementations, prior to obtaining the query embedding, the computing system can receive and ingest data. For example, the computing system can receive a data stream that includes a first data item of the one or more data items. The computing system can determine a vector representation of the first data item based on the particular encoding process, computing system can process the vector representation of the first data item with the machine-learned embedding model to obtain a first result embedding of the one or more result embeddings associated with the first data item. The computing system can store the result embedding and the vector representation of the first data item in the vector database. In some implementations, the computing system can receive a data stream including a plurality of data items, and can aggregate the plurality of data items to obtain the first data item of the one or more data items.

At operation 304, the computing system can query a vector database with the query embedding to identify one or more result embeddings, wherein the vector database comprises a plurality of embeddings for a respective plurality of vector representations of data items. In some implementations, the vector database can be a vector database management system that stores vectors, embeddings for vectors, data items represented by vectors, etc. For example, the vector database can be the vector database management system 16 of FIG. 1. Alternatively, in some implementations, the vector database can refer to a database that stores vectors and/or corresponding vector embeddings.

In some implementations, to query the vector database, the computing system can perform a nearest neighbor search for the query embedding in an embedding space comprising the query embedding and at least some of the plurality of embeddings. For example, the computing system can perform one or more Approximate Nearest Neighbor (ANN) search processes.

In some implementations, the computing system can filter the vector database prior to querying the vector database. For example, the computing system can generate an accuracy filter based on at least one of (a) the query, or (b) contextual information associated with the requesting entity, and can apply the accuracy filter to the plurality of embeddings to identify a subset of embeddings.

In some implementations, to query the vector database, the computing system can query a plurality of instances of the vector database with the query embedding to identify the one or more result embeddings. Each of the plurality of instances of the vector database can include at least some of the plurality of embeddings.

At 306, the computing system can process the query and either (a) one or more data items of the plurality of data items respectively associated with the one or more result embeddings, or (b) the one or more result embeddings with a machine-learned model to obtain a model output.

In some implementations, prior to processing the vector representation of the query, the computing system can determine a vector representation for the query based on a particular encoding process. Each of the plurality of vector representations of data items can be determined based on the particular encoding process. For example, assume the query is a query image. The particular encoding process can be a process that encodes the query image as a 16-value vector.

In some implementations, the vector database can be, or otherwise include, a time-series vector database. A time-series vector database wherein encoded vectors within the vector database (18) and data item store (22) are explicitly associated with a temporal mapping. The query and each of the plurality of data items can include temporal information. The particular encoding process can be configured to encode temporal information into one or more values of a vector representation.

In some implementations, the temporal information of the query is most similar to the temporal information of each of the one or more data items of the plurality of data items. For example, if the query is a request to describe actions performed by an entity at 4:00 pm, the temporal information of each of the data items can indicate a time of 4:00 pm, or a time substantially close to 4:00 pm. Additionally, or alternatively, in some implementations, the temporal information of the query can indicate a period of time. The temporal information of each of the one or more data items can indicate a time within the period of time. For example, assume the query is a request to retrieve financial transactions that took place between 4:00 pm and 4:03 pm. The temporal information of each retrieved data item can indicate a time within the range of 4:00 pm and 4:03 pm.

In some implementations, the one or more result embeddings can include a plurality of result embeddings respectively associated with a plurality of data items. To process the query, the computing system can determine an optimization filter based on at least one of (a) the query, or (b) contextual information associated with the requesting entity. The computing system can apply the optimization filter to either the plurality of embeddings or the plurality of data items to obtain one or more filtered result embeddings. The computing system can process the query and the one or more data items respectively associated with the one or more filtered result embeddings with the machine-learned model to obtain the model output.

At 308, the computing system can provide the model output for a requesting entity associated with the query. In some implementations, the one or more data items can respectively include one or more of sets of textual content, and wherein processing the query and the one or more data items can include processing the query and the one or more sets of textual content with an LLM to obtain a textual output.

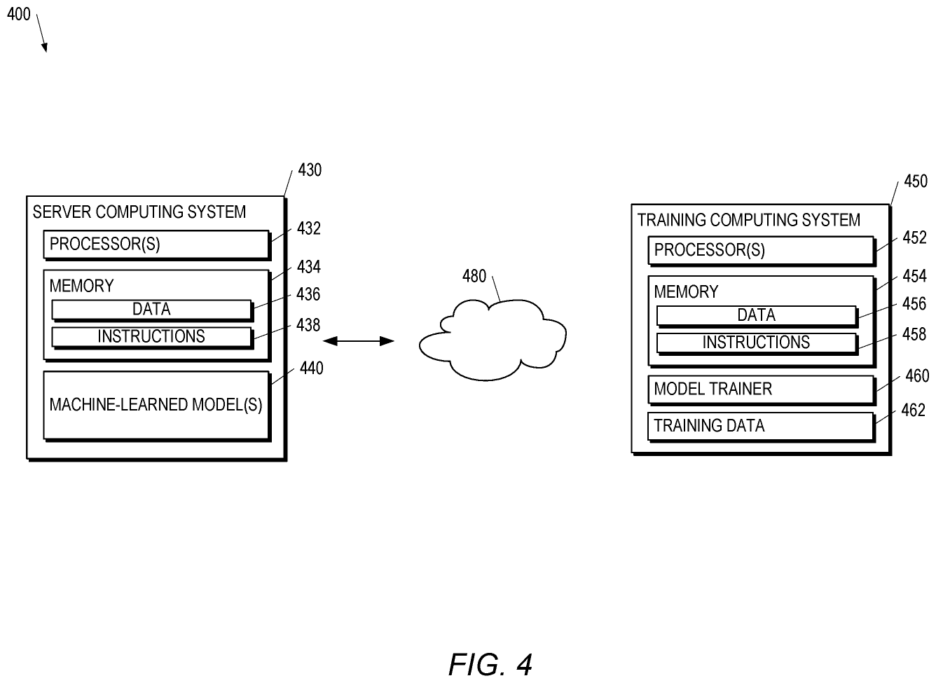

FIG. 4 depicts a block diagram of an example computing system 400 that processes determined inputs with machine-learned models according to example implementations of the present disclosure. The machine-learned models discussed herein can be, or otherwise include, any type or manner of machine-learned model(s). For example, the subject machine-learned model(s) may include machine-learned model 226 of FIG. 2, and/or machine-learned model 306 of FIG. 3. The system 400 includes a server computing system 430 and a training computing system 450 that are communicatively coupled over a network 480.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage media, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices, virtualized computing devices, compute nodes, compute instances, etc. If the server computing system includes a plurality of computing devices, the multiple computing devices can operate according to sequential computing architectures, parallel computing architectures, or some combination thereof.

The server computing system 430 can store or otherwise include one or more machine-learned models 440. For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). In particular, the machine-learned models 440 can include foundational models with many parameters trained using large quantities of information. Examples of such models include large language models.

The server computing system 430 can train the model(s) 440 via interaction with a training computing system 450 that is communicatively coupled over the network 480. The training computing system 450 can be separate from the server computing system 430 or can be a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage media. For example, the memory 454 can include RAM, ROM, flash memory devices, etc. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that is capable of training machine-learned models. Specifically, the model trainer 460 can train the machine-learned model(s) 440 implemented by the server computing system 430 using various training or learning techniques. For example, the training computing system can implement training techniques such as backwards propagation of errors. To follow the previous example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Where possible, gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained. The model trainer 460 can train the models 440 based on a set of training data 462. The training data 462 can include, for example, a large quantity of training information sufficient to train a foundational model to perform multiple types of tasks.

The model trainer 460 includes computer logic utilized to provide desired functionality. The model trainer 460 can be implemented in hardware, firmware, and/or software controlling a processor. For example, in some implementations, the model trainer 460 includes programmatic instructions stored on a storage device, loaded into a memory and executed by one or more processors. In other implementations, the model trainer 460 includes one or more sets of computer-executable instructions that are stored in a tangible computer-readable storage medium such as RAM, hard disk, or optical or magnetic media.

The network 480 can be any type of communications network, such as a local area network (e.g., intranet), wide area network (e.g., Internet), or some combination thereof and can include any number of wired or wireless links. In general, communication over the network 480 can be carried via any type of wired and/or wireless connection, using a wide variety of communication protocols (e.g., TCP/IP. HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. As an example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

It should be noted that the present disclosure describes a number of additional embodiments and/or implementations for utilizing vector databases to determine model inputs. For example, the following implementations can be implemented as described herein:

Embodiment 1: A computing system, comprising:
one or more processors; and
one or more non-transitory computer-readable media that collectively store a first set of instructions that, when executed by the one or more processors, cause the computing system to perform operations, the operations comprising:
   obtaining a query embedding for a vector representation of a query;
   querying a vector database with the query embedding to identify one or more result embeddings, wherein the vector database comprises a plurality of embeddings for a respective plurality of vector representations of data items;
   processing a set of inputs with a machine-learned model to obtain a model output, the set of inputs comprising the query and one or more of:
      (a) one or more data items of the plurality of data items respectively associated with the one or more result embeddings; or
      (b) the one or more result embeddings; and
   providing the model output for a requesting entity associated with the query.

Embodiment 2: The computing system of embodiment 1, wherein obtaining the query embedding for the vector representation of the query comprises processing the vector representation of the query with a machine-learned embedding model to obtain the query embedding for the vector representation of the query.

Embodiment 3: The computing system of embodiment 2, wherein, prior to processing the vector representation of the query, the operations comprise:
determining a vector representation for the query based on a particular encoding process; and
wherein each of the plurality of vector representations of data items are determined based on the particular encoding process.

Embodiment 4: The computing system of embodiment 3, wherein the vector database comprises a time-series vector database, wherein the query and each of the plurality of data items comprises temporal information, and wherein the particular encoding process is configured to encode temporal information into one or more values of a vector representation.

Embodiment 5: The computing system of embodiment 4, wherein the temporal information of the query is most similar to the temporal information of each of the one or more data items of the plurality of data items.

Embodiment 6: The computing system of embodiment 5, wherein the temporal information of the query is indicative of a period of time, and wherein the temporal information of each of the one or more data items is indicative of a time within the period of time.

Embodiment 7: The computing system of embodiment 3, wherein, prior to obtaining the query embedding, the operations comprise:
receiving information indicative of the query from the requesting entity.

Embodiment 8: The computing system of embodiment 3, wherein, prior to obtaining the query embedding, the operations comprise
receiving information from the requesting entity; and
generating the query based on the information from the requesting entity.

Embodiment 9: The computing system of embodiment 3, wherein, prior to obtaining the query embedding, the operations comprise:
receiving a data stream comprising a first data item of the one or more data items;
determining a vector representation of the first data item based on the particular encoding process;
processing the vector representation of the first data item with the machine-learned embedding model to obtain a first result embedding of the one or more result embeddings associated with the first data item; and
storing the result embedding and the vector representation of the first data item in the vector database.

Embodiment 10: The computing system of embodiment 9, wherein receiving the data stream comprising the first data item of the one or more data items comprises:
receiving a data stream comprising a plurality of data items; and
aggregating the plurality of data items to obtain the first data item of the one or more data items.

Embodiment 11: The computing system of embodiment 1, wherein querying the vector database comprises performing a nearest neighbor search for the query embedding in an embedding space comprising the query embedding and at least some of the plurality of embeddings.

Embodiment 12: The computing system of embodiment 11, wherein performing the nearest neighbor search comprises performing one or more Approximate Nearest Neighbor (ANN) search processes.

Embodiment 13: The computing system of embodiment 1, wherein the one or more data items respectively comprise one or more of sets of textual content; and
wherein processing the query and the one or more data items comprises processing the query and the one or more sets of textual content with a large language model (LLM) to obtain a textual output.

Embodiment 14: The computing system of embodiment 1, wherein querying the vector database with the query embedding comprises:
generating an accuracy filter based on at least one of:
   (a) the query; or
   (b) contextual information associated with the requesting entity; and
applying the accuracy filter to the plurality of embeddings to identify a subset of embeddings; and
querying the subset of embeddings with the query embedding to identify the one or more result embeddings.

Embodiment 15: The computing system of embodiment 1, wherein the one or more result embeddings comprises a plurality of result embeddings respectively associated with a plurality of data items; and
wherein processing the query and the one or more data items with the machine-learned model comprises:
   determining an optimization filter based on at least one of:
      (a) the query; or
      (b) contextual information associated with the requesting entity;
   applying the optimization filter to either the plurality of embeddings or the plurality of data items to obtain one or more filtered result embeddings; and
   processing the query and the one or more data items respectively associated with the one or more filtered result embeddings with the machine-learned model to obtain the model output.

Embodiment 16: The computing system of embodiment 1, wherein querying the vector database with the query embedding comprises querying a plurality of instances of the vector database with the query embedding to identify the one or more result embeddings, wherein each of the plurality of instances of the vector database comprises at least some of the plurality of embeddings.

What is claimed is:

1. A computer-implemented method, comprising:
obtaining, by a computing system comprising one or more computing devices, a query embedding for a vector representation of a query;
querying, by the computing system, a vector database with the query embedding to identify one or more result embeddings, wherein the vector database comprises a plurality of embeddings for a respective plurality of vector representations of data items;
processing, by the computing system, a set of inputs with a machine-learned model to obtain a model output, the set of inputs comprising the query and one or more of:
(a) one or more data items of the plurality of data items respectively associated with the one or more result embeddings; or
(b) the one or more result embeddings; and
providing, by the computing system, the model output for a requesting entity associated with the query.

2. The computer-implemented method of claim 1, wherein obtaining the query embedding for the vector representation of the query comprises:
processing, by the computing system, the vector representation of the query with a machine-learned embedding model to obtain the query embedding for the vector representation of the query.

3. The computer-implemented method of claim 2, wherein, prior to processing the vector representation of the query, the method comprises:
determining, by the computing system, a vector representation for the query based on a particular encoding process; and
wherein each of the plurality of vector representations of data items are determined based on the particular encoding process.

4. The computer-implemented method of claim 3, wherein the vector database comprises a time-series vector database, wherein the query and each of the plurality of data items comprises temporal information, and wherein the particular encoding process is configured to encode temporal information into one or more values of a vector representation.

5. The computer-implemented method of claim 4, wherein the temporal information of the query is most similar to the temporal information of each of the one or more data items of the plurality of data items.

6. The computer-implemented method of claim 4, wherein the temporal information of the query is indicative of a period of time, and wherein the temporal information of each of the one or more data items is bounded within that period of time.

7. The computer-implemented method of claim 3, wherein, prior to obtaining the query embedding, the method comprises:
receiving, by the computing system, information indicative of the query from the requesting entity.

8. The computer-implemented method of claim 3, wherein, prior to obtaining the query embedding, the method comprises:
receiving, by the computing system, information from the requesting entity; and
generating, by the computing system, the query based on the information from the requesting entity.

9. The computer-implemented method of claim 3, wherein, prior to obtaining the query embedding, the method comprises:
receiving, by the computing system, a data stream comprising a first data item of the one or more data items;
determining, by the computing system, a vector representation of the first data item based on the particular encoding process;
processing, by the computing system, the vector representation of the first data item with the machine-learned embedding model to obtain a first result embedding of the one or more result embeddings associated with the first data item; and
storing, by the computing system, the result embedding and the vector representation of the first data item in the vector database.

10. The computer-implemented method of claim 9, wherein receiving the data stream comprising the first data item of the one or more data items comprises:
receiving, by the computing system, a data stream comprising a plurality of data items; and
aggregating, by the computing system, the plurality of data items to obtain the first data item of the one or more data items.

11. The computer-implemented method of claim 1, wherein querying the vector database comprises performing, by the computing system, a nearest neighbor search for the query embedding in an embedding space comprising the query embedding and at least some of the plurality of embeddings.

12. The computer-implemented method of claim 11, wherein performing the nearest neighbor search comprises performing, by the computing system, one or more Approximate Nearest Neighbor (ANN) search processes.

13. The computer-implemented method of claim 1, wherein the one or more data items respectively comprise one or more of sets of textual content; and
wherein processing the set of inputs comprising the query and the one or more data items comprises processing, by the computing system, the query and the one or more sets of textual content with a large language model (LLM) to obtain a textual output.

14. The computer-implemented method of claim 1, wherein querying the vector database with the query embedding comprises:
generating, by the computing system, an accuracy filter based on at least one of:
(a) the query; or
(b) contextual information associated with the requesting entity; and
applying, by the computing system, the accuracy filter to the plurality of embeddings to identify a subset of embeddings; and
querying, by the computing system, the subset of embeddings with the query embedding to identify the one or more result embeddings.

15. The computer-implemented method of claim 1, wherein the one or more result embeddings comprises a plurality of result embeddings respectively associated with a plurality of data items; and
wherein processing the query and the one or more data items with the machine-learned model comprises:
determining, by the computing system, an optimization filter based on at least one of:
(a) the query; or
(b) contextual information associated with the requesting entity;
applying, by the computing system, the optimization filter to either the plurality of embeddings or the plurality of data items to obtain one or more filtered result embeddings; and
processing, by the computing system, the query and the one or more data items respectively associated with the one or more filtered result embeddings with the machine-learned model to obtain the model output.

16. The computer-implemented method of claim 1, wherein querying the vector database with the query embedding comprises:
querying, by the computing system, a plurality of instances of the vector database with the query embedding to identify the one or more result embeddings, wherein each of the plurality of instances of the vector database comprises at least some of the plurality of embeddings.

17. A computing system, comprising:
one or more processors; and
one or more non-transitory computer-readable media that collectively store a first set of instructions that, when executed by the one or more processors, cause the computing system to perform operations, the operations comprising:
obtaining a query embedding for a vector representation of a query;
querying a vector database with the query embedding to identify one or more result embeddings, wherein the vector database comprises a plurality of embeddings for a respective plurality of vector representations of data items;
processing a set of inputs with a machine-learned model to obtain a model output, the set of inputs comprising the query and one or more of:
(a) one or more data items of the plurality of data items respectively associated with the one or more result embeddings; or
(b) the one or more result embeddings; and
providing the model output for a requesting entity associated with the query.

18. The computing system of claim 17, wherein obtaining the query embedding for the vector representation of the query comprises:
processing the vector representation of the query with a machine-learned embedding model to obtain the query embedding for the vector representation of the query.

19. The computing system of claim 18, wherein, prior to processing the vector representation of the query, the operations comprise:
determining a vector representation for the query based on a particular encoding process; and
wherein each of the plurality of vector representations of data items are determined based on the particular encoding process.

20. One or more non-transitory computer-readable media that collectively store a first set of instructions that, when executed by one or more processor devices, cause the one or more processor devices to perform operations, the operations comprising:
obtaining a query embedding for a vector representation of a query;
querying a vector database with the query embedding to identify one or more result embeddings, wherein the vector database comprises a plurality of embeddings for a respective plurality of vector representations of data items;
processing a set of inputs with a machine-learned model to obtain a model output, the set of inputs comprising the query and one or more of:
(a) one or more data items of the plurality of data items respectively associated with the one or more result embeddings; or
(b) the one or more result embeddings; and
providing the model output for a requesting entity associated with the query.
